(19) United States
(12) Patent Application Publication
(10) Pub. No.: US 2012/0297316 A1
(43) Pub. Date: Nov. 22, 2012

(54) METHODS AND APPARATUS FOR HANDLING OUTGOING ELECTRONIC MESSAGES IN A USER TERMINAL

(75) Inventor: Teddy Ercegovic, (US)

(73) Assignee: Ferring B.V.

(21) Appl. No.: 13/471,929

(22) Filed: May 15, 2012

Related U.S. Application Data
(60) Provisional application No. 61/493,613, filed on Jun. 6, 2011.

(30) Foreign Application Priority Data
May 17, 2011 (EP) 11166435.5

(51) Int. Cl. G06F 3/01; G06F 15/16

(52) U.S. Cl. 715/752

(57) ABSTRACT

A method and User Terminal (UT) for handling an outgoing electronic message. The UT receives a “send” command from a user, where the “send” command is associated with the outgoing electronic message. The outgoing electronic message is buffered in a time delay buffer for a predetermined time period. During that time period, the user is displayed, using a Graphical User Interface (GUI), an indication of the remaining time before the predetermined time period has elapsed. The message is sent without any further user input from the user if no abort command is received from the user.

### FIELD OF THE INVENTION

The invention relates generally to methods and apparatus for handling outgoing electronic messages in a User Terminal (UT).

### BACKGROUND

Electronic messaging, such as electronic mail (email), is now widely used as means for business and professional communication. When email was developed it was primarily intended for spreading details regarding technical information and research projects. In the beginning, email was in particular means for electronic communication between software and data communication engineers.

Today, email is one of the primary means for corporate communication. Email is used for sending messages both within a corporation and to other actors residing outside the corporation. However, email is also widely used for private communication with colleagues, friends and family. Hence, the content of the emails sent from an email address may range from confidential technical or business related information to private content such as greetings, jokes or just social chatter or gossip. Although the content of an email message may be of private character, it can always be referred to as communicated from a corporation hosting the email address. Email addresses are normally structured to comprise the name of the sender and the name, or an abbreviation of, the corporation to which the sender is employed by or associated to, e.g., a message sent from the email address “john.doe@alphacorp.com” could be claimed to represent Alpha Corporation, and that the message is sent by John Doe in his service at Alpha Corporation, regardless of the content or the addressee of the email.

The users, e.g., employees, normally send large number of electronic messages each and every day. The users are also commonly engaged in several parallel ongoing digital conversations using electronic messaging. Composing an electronic message can be done quickly and the action of sending the message is relatively easy. This may result in insufficient reflection and attention being paid to the content and the identity of the addressee prior to sending the message.

Carelessly drafted emails may create unintended liabilities or bad will for the organization which the user intentionally or unintentionally is seen to represent. Misaddressed messages can disclose confidential information and may result in permanent loss of property, e.g., trade secrets or other types of intellectual property. Emails comprising unsuitable content are sometimes sent due to lack of reflection, an upset mood, by mistake and sometimes also on purpose. This use of email may lead to significant legal and financial risk to the corporation which is providing the email account. In fact, an email comprising unsuitable content may cause problems several years after it has been sent. Yet another problem with electronic messages is that they are easy to send to several recipients. Hence, a message with unsuitable content which is sent to a large group of recipients may cause significant damage.

Systems and mechanisms have been proposed which searches for specific words or phrases with or without human intervention. While these systems may be able to detect certain words or other potentially undesirable keyword patters, language containing unsuitable or problematic content can be quite subtle and therefore almost impossible to detect. The keyword patterns may also comprise a lot of redundant subtle information which is associated with dialects or different languages which is very problematic to detect and restrain.

With reference to FIG. 1, a system according to the prior art having those above described drawbacks will now be described. The flow of events in the system described in FIG. 1 will represent a user using a first UT 101 in order to send an e-mail to a second UT 105. The first UT 101 resides within an access network 100. In FIG. 1, the access network 100 comprises a filter with rules for allowable content in email send from the access network 100. Hence, the first access network could represent a corporate network and the first UT could represent a corporate provided UT having a corporate email address. The first UT 101 sends, in action 1:1, the message which is intercepted by logic 102 for parsing, controlling and analyzing the content based on predetermined filters and rules for allowable content. The content is analyzed in action 1:2 in order to determine whether or not the message can be sent. The logic 102 comprising filter and rules normally demands large reference databases and large processing resources in order to successfully filter the outgoing messages. However, one set of filter and rules is normally only compatible with one language. Corporate environments having several languages also requires additional redundant filter and rules. The outgoing emails and attachments are normally controlled in real time which may demand interim storage, distributed processing power and high performance network data transfer capabilities in order to handle hundreds or thousands of emails in parallel.

If the message comprises unallowable content, then the filter and rules logic 102 prompts the first UT 101 to confirm the content or redraft the email in action 1:3. Once the user has confirmed the content in action 1:4, the message is sent to the first email server 103, which is indicated by action 1:5. The message may be stored locally in the first e-mail server 103 in action 1:6 and thereafter delivery to the second UT using a Wide Area Network (WAN), e.g. Internet, and via its corresponding second email server 104 indicated by action 1:7. Action 1:8 shows local storage, spam filter checks and other applicable controls performed by the second email server 104 before delivering the email to the second UT 105 indicated by action 1:9. Although the second UT 105 is associated with the second e-mail server 104 outside the access network 100 a similar solution, according to the prior art, could be used if the first UT and the second UT are both associated to the same e-mail server and residing within the same access network.

Others have attempted to work in the field of enhanced functionality in systems for electronic messaging, but without fully presenting a satisfying solution. Thus, there is still a need for improvements and new solutions. Examples of previous attempts are briefly discussed below.

U.S. Pat. No. 6,460,074 describes an electronic mail system which includes an electronic mail utility which comprises an analysis function and a reconsideration prompting module. The reconsideration prompting module prompts the user for acceptance, ensuring that the user really wishes to send the content of the email, if unsuitable or abnormal content is identified. The effectiveness of this solution is depending on the electronic mail utility's ability to interpret the content of the email message. Thus, this solution is, as previously discussed, not suitable for multi-language environments. This solution does not offer a reconsideration period but rather just asks the user to yet another time reconsider the action of sending the email. Also this solution will demand significant computing resources.

WO 2010/094626 A1 describes a solution comprising a method for handling an outgoing message. The method comprises receiving a message which comprises content and one or more intended recipients. Thereafter, one or more rules are selected based on the recipients of the message. The rules are used to check whether or not the message comprises inappropriate content and if so perform a predetermined corrective action. Also in WO 2006/088915 A1a system for applying policies or rules to electronic messages is disclosed. This system runs a series of analysis steps on an intercepted outgoing message. As a consequence of the analysis steps, certain content may be automatically removed, the user may be asked to redraft the message or a copy may be held in a non-user accessible folder. The content analysis steps and the actions taken may be determined by the sender, or they may be centrally managed and determined by the email address provider or a combination of the two.

These two solutions require the rules/policies to be adapted to the language, dialect and format of the potentially inappropriate content. Hence, these solutions may require access to large resources in order interpret and process the content of the outgoing message. These solutions will thus neither scale well in terms of different languages and dialects nor in terms of an increasing amount of sent emails.

US 2007/0067436 A1 describes an etiquette agent for preventing and eliminating inappropriate messages based on the predefined etiquette rules. The rules may be formed based on the content but can also interpret the state of the user by for example analyzing the variation of keystroke patterns or by employing a chemical sensor. If a message, which is violating the predefined etiquette rules, the user may be prompted to confirm the action of sending the message with a password. In another alternative to the message is returned to sender with an indication of the etiquette violation and thus not delivered to the intended recipient. Although this solution also analyzes other parameters than the actual content of the message, inappropriate content may be sent anyway due to limitations of the possible analysis.

WO 2009/099424 A1 describes a method and system for managing disclosure of information in a virtual community. Also this solution examines the content of the message which the sending user wants to disclose in the virtual community. Based on the content, the disclosure system prompts the user to change the content. Also this solution is static from the perspective of detecting unwanted content. For example, the solution is adapted for recognizing personal data such as date of birth. However, this information may be represented in various ways by phrases and words without any numbers or the typical date of birth format. Also in this solution, the user can confirm the message without any further reflection of the prompted system message. Therefore, this solution may not prevent rashly drafted messages. The user only needs one more click to send the message.

Some of the email systems of today offer functionality for removing emails which have been sent, such as the recall operation which recalls a previously sent email. This solution is however vulnerable in certain use cases and is not sufficiently robust from several technical perspectives. For example, if the message has already been delivered and if the receiving user has already read the content of the email, then the recall function is useless. It may in fact have an opposite effect in drawing even more attention to the email which the sender wanted to recall. From a technical perspective, the recall function normally only works sufficiently if the sender and the receiver are associated with the same email server which supports the recall operation. If the recipient's email server does not comply with the recall function or that the sender and the receiver do not share email server, a recall message will appear attracting more attention to the message which was subject for recall.

### SUMMARY

According to one aspect, a method for handling an outgoing electronic message in a User Terminal (UT) is provided. The UT receives a “send” command from a user of the UT, where the “send” command is associated with the outgoing electronic message. The outgoing electronic message is buffered in a time delay buffer for a predetermined time period. An indication of the remaining time before the predetermined time period has lapsed is displayed to the user using a Graphical User Interface (GUI) comprised in the UT. The outgoing electronic message is sent without further user interaction when the predetermined time period has lapsed.

According to another aspect, a UT adapted for handling an outgoing electronic message is provided. The UT comprises a receiving unit which may be adapted to receive a “send” command from a user of the UT. The “send” command can be associated with the outgoing electronic message. The UT further comprises a time delay buffering unit which may be adapted to buffer the outgoing electronic message for a predetermined time period. The UT may further comprise a GUI in a display unit which may be adapted to display, to the user, an indication of the remaining time before the predetermined time period has lapsed. The UT further comprises a sending unit adapted to send the outgoing electronic message when the predetermined time period has lapsed. The outgoing electronic message is sent without receiving any further interaction from the user.

The method and arrangement described above may contribute to a decreased amount of emails having harmful or unsuitable content. The provided method and arrangement may also enable a provider or an electronic message system to introduce a higher level of liability to the sending user. The prior art is focused on improving the analysis function of the email handling systems. However, as identified by the inventor, the problem may not necessarily be related to the content or the structure of the outgoing electronic message. Instead, the identified problem may be associated with the user's lack of opportunity to reflect over a hastily drafted message.

The above method and arrangement may be configured and implemented according to different embodiments. In one example embodiment, the outgoing electronic message may be removed from the time delay buffer if an “abort” command is received from the user.

According to another example embodiment, the GUI may comprise at least a top layer and a bottom layer of display, where the remaining time may be displayed in the top layer.

According to another example embodiment, where the remaining time can be continuously displayed as one of: an interactive progress bar, a numerical or graphical countdown indicator or a color indicator.

According to yet another example embodiment, where the predetermined time period is set based on at least one of: the identity of addressees of the outgoing electronic message, the number of addressees of the outgoing electronic message, the size of the outgoing electronic message, or a predefined relationship between the outgoing electronic message and a previously received electronic message.

According to yet another example embodiment, where the predetermined time period represents a time period wherein the UT registers user interaction.

Further possible features and benefits of this solution will become apparent from the detailed description below.

### BRIEF DESCRIPTION OF THE DRAWINGS

FIG. 1 is a block diagram illustrating a filter and rules unit for intercepting and analyzing outgoing emails, according to the prior art.

FIG. 2a is a flow chart illustrating a procedure for handling outgoing electronic messages in a user terminal, according to exemplary embodiments.

FIG. 2b is a flow chart illustrating a procedure for determining and assigning a time period to an outgoing message which is placed in a time delay buffer, according to exemplary embodiments.

FIG. 2c is a flow chart illustrating a procedure for regulating the remaining time, according to exemplary embodiments.

FIG. 3a is a block diagram illustrating an arrangement of a user terminal adapted to handle outgoing electronic messages, according to exemplary embodiments.

FIG. 3b is a block diagram illustrating an arrangement of a user terminal and an email server adapted to handle outgoing electronic messages, according to exemplary embodiments.

FIG. 3c is a time diagram scenario illustrating an electronic outgoing message placed a send buffer where the remaining time is only decreased when user interaction is detected, according to exemplary embodiments.

FIG. 4 is a block diagram illustrating one or more users associated with a buffer comprising outgoing electronic messages in an email server, according to exemplary embodiments.

FIG. 5a is an exemplary view of a graphical user interface indicating the remaining time before an outgoing electronic message is sent, according to exemplary embodiments.

FIG. 5b is an exemplary view of a window comprising graphical elements for indicating the remaining time of multiple outgoing emails currently held in the buffer for outgoing email, according to exemplary embodiments.

FIG. 5c is an exemplary view of a window comprising graphical elements for indicating the remaining time of multiple outgoing emails, according to exemplary embodiments.

FIG. 6 is a block diagram illustrating an arrangement in a user terminal, according to exemplary embodiments.

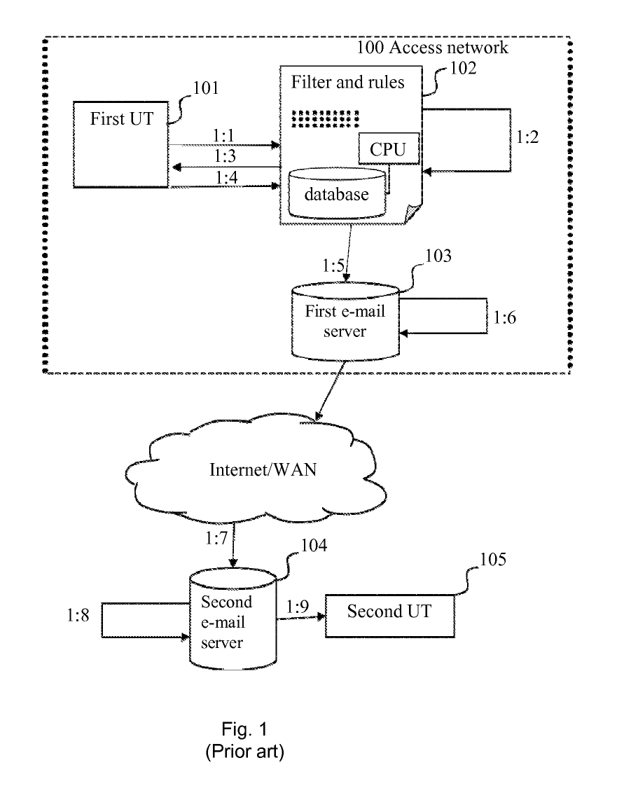

### DETAILED DESCRIPTION

The prior art is primarily focused on improving the analysis function of email handling systems as discussed above. Such improvement is normally achieved by improving the analysis function in order to increase the likelihood to detect unsuitable content and to take a corrective action. However, prior art systems focused on the content or the structure of the outgoing electronic message. Incremental improvement of the prior art solutions will not produce satisfying solutions for decreasing the amount of electronic messages with unsuitable or harmful content.

Instead, embodiments of the present invention address a user's lack of opportunity to reflect over a drafted message. For example, if a delay is introduced in correspondence of electronic messages, then the user may be provided with time for reflection in order to abort the procedure of sending the electronic message before it is actually transmitted.

Briefly described, a process is provided for handling outgoing electronic messages. The process may enable users of an electronic message system to abort and also recall electronic messages which has been buffered but not yet sent to the recipient. The process is thus independent of the linguistic content of the electronic message and does thus not require any dedicated resources for analyzing the content of the electronic message. The process may be used to decrease the amount of emails having harmful or unsuitable content. The process may also enable a provider of an electronic message system to introduce a higher level of liability to the sending user.

Embodiments consistent with the present invention may also slow down an ongoing correspondence, thereby enabling the user to rethink and reconsider the action of actually sending each message. This may be of particular importance when email conversations comprise emotional content causing the users' engaged in the conversation to act less rational. Hence, users of a system where this solution is applied may be less prone to send electronic messages in a precipitate manner. However, an outgoing message is not blocked, but will be sent without any further user command or invocation regardless of the content.

In this description, the term “electronic message” may be, for example, an electronic message which is sent to a recipient using a Local Area Network (LAN) or a WAN. The electronic message may comprise text and/or attachments. Possible examples of electronic messages are email and instant messages (IM). Wherever the term email is used in this description or in the drawings, it should be noted that the more general term electronic message could be used instead.

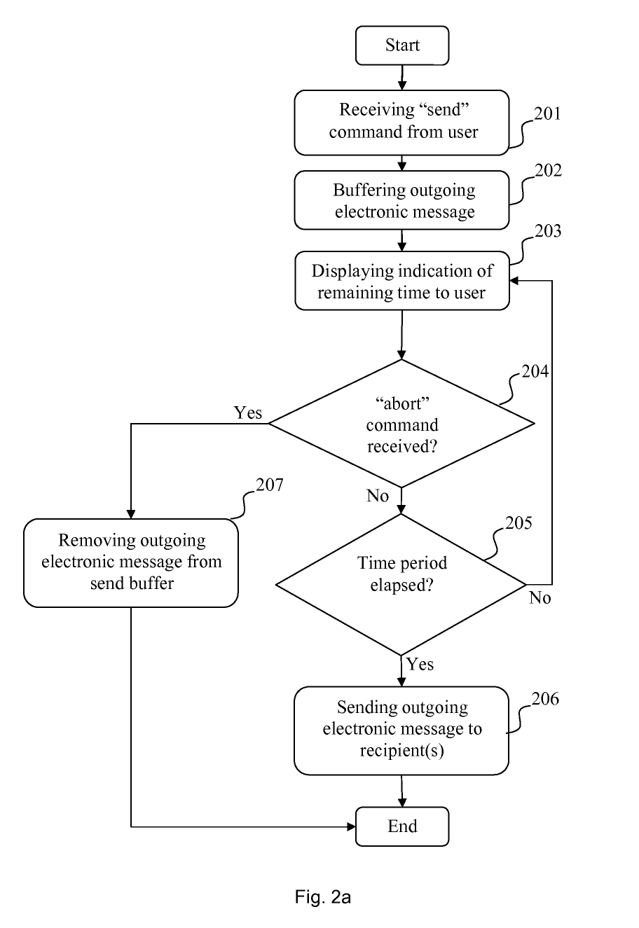

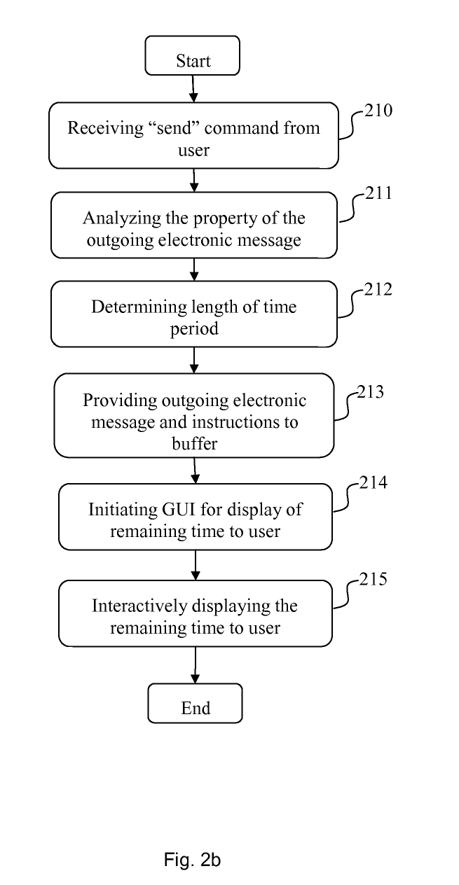

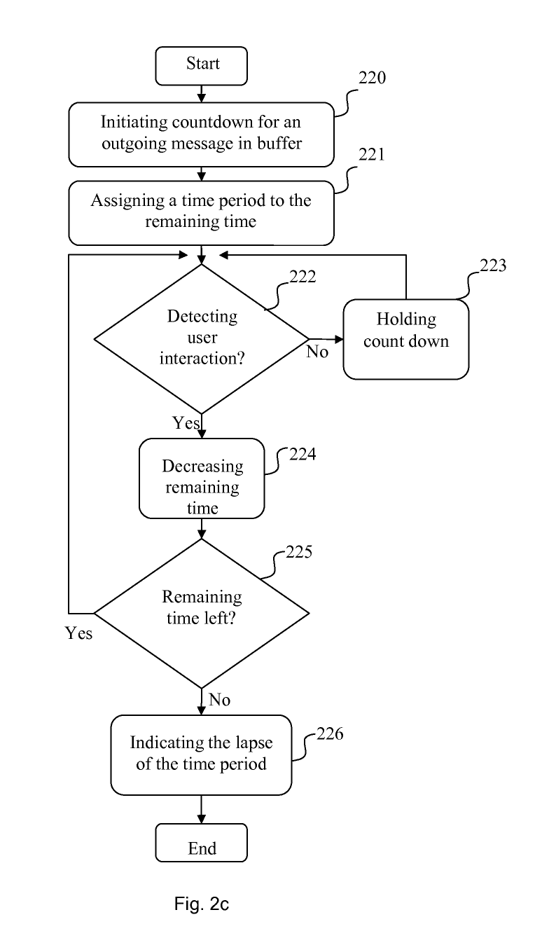

With reference to FIG. 2a, a procedure for handling outgoing emails will now be described. The procedure will describe a flow for sending one outgoing electronic message. However, the procedure may be performed for several parallel messages.

In a first action 201, a UT receives a “send” command from a user of the UT. The “send” command is associated with an outgoing electronic message which may be locally stored in the UT. The outgoing electronic message is buffered in a time delay buffer for a time period which may be predetermined, which is indicated by action 202. Thus, the user of the UT has sent the outgoing electronic message by issuing the “send” command, the outgoing electronic message has however not left the UT and not yet been released into the WAN/Internet for delivery. Instead, the outgoing electronic message is temporarily held in escrow in a time delay buffer. The predetermined time period starts when in action 201, when the user issues the “send” command. Then, in action 203 the UT displays a message to the user. The displayed message comprises the remaining time before the outgoing electronic message is sent and optionally prompting instructions of how to abort and prevent the outgoing electronic message from being sent. This may be done with figures, drawings or icons to achieve compatibility with any language. It may however also be prompted in text. The displayed message may also comprise other types of information and instructions, such as but not limited to corporate email policies, email user agreements or other type of messages which may more clearly place liability to the employee, i.e., the actual sender, instead of the employer, i.e., the email address provider.

The remaining time is continuously displayed to the user using a Graphical User Interface (GUI) of the UT. According to one embodiment, the GUI may display two or more layers of graphical information, where a top layer is superimposed to a bottom layer. In such embodiment, the GUI may display the remaining time and associated “abort” instructions in the top layer of the GUI. The GUI may also show the remaining time in an interactive mode, such that the user continuously can see and interpret the change and amount of remaining time. This may be done by an interactive progress bar, a pie chart, color coding or by numerical or alphabetical countdown. Also other graphical elements are possible.

The length of the time period may be set based on a static length indicator or based on dynamic parameters. According to one embodiment, the dynamic parameters may be any one of: the identity of any addressee(s) of the outgoing electronic message, the number of addressees of the outgoing electronic message or the size of the electronic message. Yet another parameter may be based on the relationship between the electronic message and a previously received electronic message. One example of such relationship may be the time passed from receiving a message to when the reply is drafted and sent. A short time passed from receiving a message to drafting and sending a response may indicate that the time in the time delay buffer should be set to a longer time period in order to sufficiently slow down the correspondence.

According to one particular example embodiment, the time period may range between 1 to 5 minutes. According to another example, the time period could be predetermined to range between 2 to 3 minutes.

The sending procedure of the electronic message may at any time, before the remaining time has lapsed, be aborted, which is indicated by action 204. If the user issues an “abort” command, the electronic message is removed from the send buffer and the procedure of FIG. 2a has to be restarted in order to send the email as indicated by the optional action 207. If no “abort” command has been received, and the time period has lapsed as indicated by action 205, the email is automatically sent in action 206, without any further input or interaction from the user of the UT.

The procedure described with reference to FIG. 2a may naturally handle two or more outgoing electronic messages in parallel. In such scenario, a displaying action is performed for each electronic message. Hence, if two outgoing electronic messages are buffered, then also two indications of the individually remaining times are displayed.

With reference to FIG. 2b, an optional example procedure which may initiate the procedure of FIG. 2a will be described. In a first action 210, a UT receives a “send” command from a user of the UT. The “send” command can be associated with an email which may be locally stored in the UT. The UT may then analyze one or more properties of the outgoing message, as indicated by action 211, in order to create basis for determining the length of the time period in the time delay buffer.

In action 212, the length of the time period may be determined based on the analysis of the properties in action 211. Possible properties may for example be any one of: the identity of any addressee(s) of the outgoing electronic message, the number of addressees of the outgoing electronic message or the size of the electronic message. Yet another parameter may be based on the relationship between the electronic message and a previously received electronic message. One example of such relationship may be the time passed from receiving a message to when the reply is drafted and sent. A short time passed from receiving a message to drafting and sending a response may indicate that the time in the time delay buffer should be set to a longer time period in order to sufficiently slow down the correspondence.

The determined length of the time period and the outgoing message is provided to the buffer in action 213. Then, the UT is ready to begin the display of an indication of the remaining time to the user using the GUI. Hence, the GUI is initiated with the necessary parameters, such as an identity indicator of the message and the individually associated time period, which is indicated in action 214. Thereafter, in action 215, the displaying of the remaining time to the user may begin. When the displaying begins, also the an “abort” command may be received as described in action 204 in FIG. 2a, in order to interrupt the “send” procedure of the outgoing electronic message.

According to another optional embodiment of the procedure described above, the time period will only comprise time when the user is active, i.e. making any registerable input to the UT. According to such embodiment, the remaining time will only decrease if the UT receives registerable user input indicating the presence of the user. With reference to FIG. 2c, a procedure for this optional embodiment will be described.

In action 220 the outgoing message is placed in the buffer and the procedure for countdown is thereby initiated. The outgoing message is assigned with a time period for which it will be buffered before it may be sent, which is indicated in action 221. The actions 220 and 221 may be implemented according with the procedure described with reference to FIG. 2b above.

The UT is then detecting user interaction in action 222. If no user interaction can be detected, then the initiated countdown is held, i.e., the decrement of the remaining time is temporarily paused, as indicated by action 223. Hence, if the user is not presently using the UT, then the remaining time will not decrease in order to strive for actual exposure of the remaining time to the user. However, if user interaction is detected, then the remaining time may be decreased, as indicated in action 224. If the remaining time still is above zero, as determined in action 225, then the procedure returns to action 222 in order to detect further user interaction. When the time period has lapsed, i.e., when the remaining time is less than or equals zero in action 225, then the UT may indicate, in action 226, that the time period has lapsed and that the outgoing electronic message may be sent without any further user interaction.

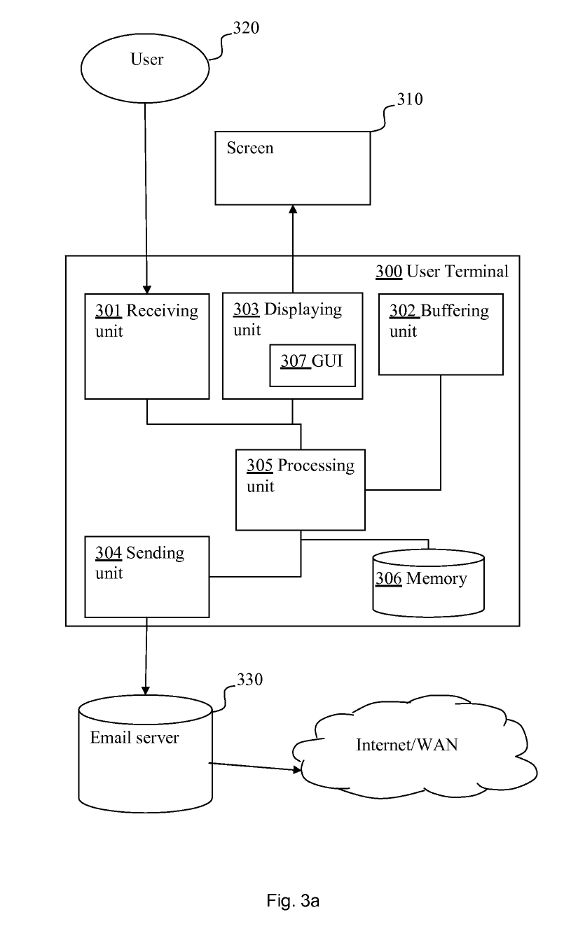

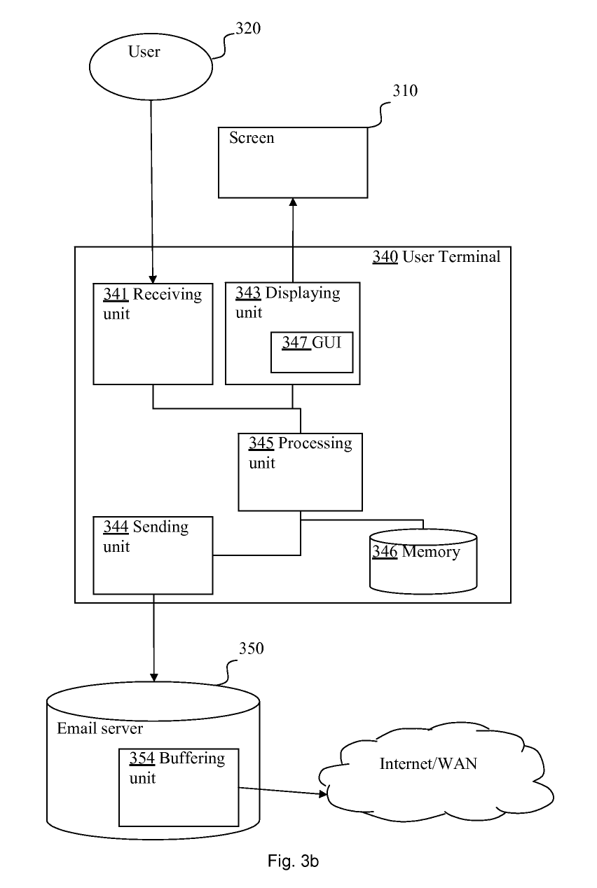

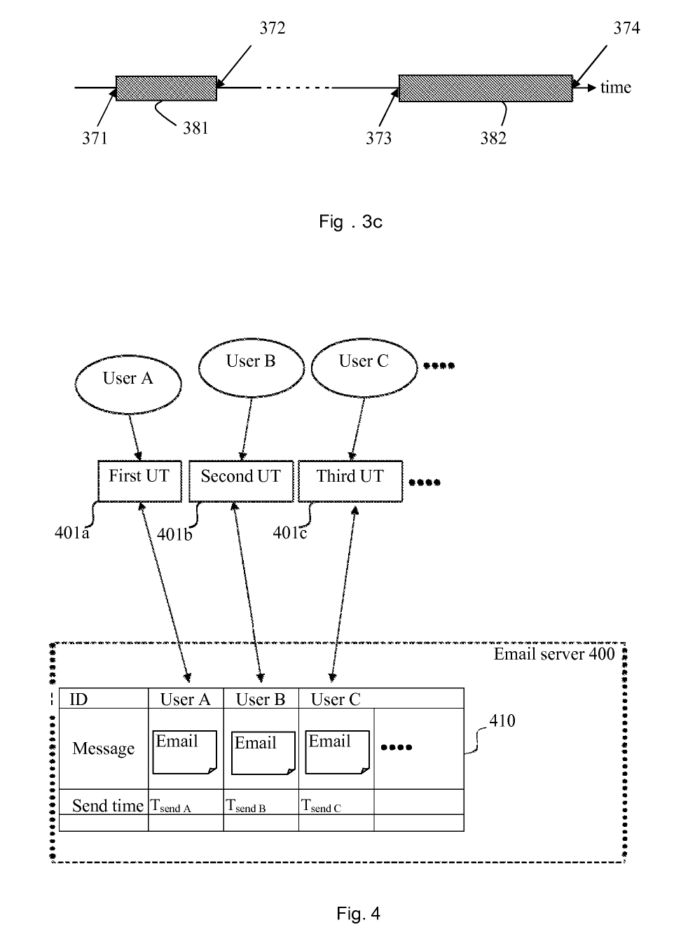

With reference to FIG. 3a, a UT 300 adapted to perform the related actions of the flow charts shown in FIG. 2a-c, will now be described. Hence, the UT 300 is adapted to buffer an outgoing electronic message for a predetermined time period, where the user is enabled to abort the transmission of the outgoing electronic message during the predetermined time period. If no “abort” command is received from the user, then the outgoing electronic message is automatically sent without any further user interaction, i.e. no further input or confirmation from the user.

The UT 300 comprises a receiving unit 301, which is adapted to receive commands from a user 320. The receiving unit 301 may for instance form a part of an Input/output (I/O) module having a keyboard, touch screen or other a similar device for registering user input. The UT 300 further comprises a buffering unit 302 which is adapted to buffer an electronic message for a predetermined time period. The time period starts when the receiving unit 301 receives a “send” command from the user 320. The UT 300 also comprises a processing unit 305 and a memory 306. The processing unit 305 is adapted to provide timing indications and to orchestrate and provide the various units 301-304 and 307 with data and instructions which may be stored in the memory.

The UT 300 further comprises a displaying unit 303 which is adapted to display the remaining time before the electronic message is automatically sent. The displaying unit 303 may be adapted to provide visualization instructions to a screen, e.g. a computer monitor, a touch screen, or any other type of monitor. The displaying unit comprises a GUI 307 capable of visualizing the remaining time in different ways. According to one embodiment, the GUI 307 is adapted to visualize the remaining time in at least two layers, a bottom layer and a top layer. The GUI 307 may then be adapted to always display the remaining time on a top layer such that it is always present on the screen. The GUI may also be adapted to interactively show the remaining time by color codes, a progress bar, a progress pie, alphabetical or numerical countdowns. In one particular embodiment, the buffering unit 302 and the displaying unit 303 may be adapted to only decrease the remaining time, i.e. count down, when the UT 300 registers user input, indicating the presence of the user 320.

The receiving unit 301 is also adapted to receive an “abort” command, associated with one or more electronic messaged in the buffering unit 302, from the user 320. If the receiving unit 301 receives an “abort” command, then the electronic message(s) is discarded from the buffering unit 302 and may be restored as drafts of unsent messages stored in the memory 306. The UT 300 further comprises a sending unit 304 adapted to send the electronic message if the receiving unit 301 is not receiving any “abort” command during the predetermined time period associated with an electronic message in the buffering unit 302. The sending unit 304 may then provide the electronic message to the server 330 for distribution according to the protocol of the message type. e.g. if the electronic message is an email the message is provided to the hosting email server 330 according a predetermined email protocol such as Internet Message Access Protocol (IMAP), Post Office Protocol 3 (POP3), Simple Mail Transfer Protocol (SMTP) or even Hypertext Transfer Protocol (HTTP).

According to one example embodiment of the UT 300, the predetermined time period for in which each individual electronic message will be buffered before sending may depend on one or more parameters. The buffering unit 302 may be adapted to determine the length of the time period before the message is automatically sent based on at least one of: the addressee(s) of electronic message, the number of addressees of the electronic message, the size of the outgoing electronic message, or a relationship between the electronic message and a previously received electronic message.

Although FIG. 3a shows an UT 300 comprising isolated units, one or more of the functional units of the UT 300 may be implemented or integrated with the server for sending the message 330. One such example embodiment will now be described with reference to FIG. 3b. A buffering unit 354 may be implemented into the email server which the user 320 is associated with. The UT 340 also comprise a receiving unit 341, a displaying unit 343, a processing unit 345, memory 346 and a sending unit 344 which may have a functionality which corresponds to the units and arrangements described in FIG. 3a.

The buffer unit 354, in FIG. 3b, may thus serve several UTs and where the outgoing electronic messages are buffered in the email server 350 instead of in the UT 340. By letting the email server 350 comprise the buffering unit 354, the buffering of the outgoing messages may be performed without the consent or involvement of the user 320. Thus, the buffering and displaying of the remaining time before the message may be forced to all users associated with the UT 340 and/or the email server 350. In such embodiment, the buffering unit 354 in the email server 350 may be adapted to first receive the outgoing electronic message from the sending unit 344. If no “abort” request is provided, then the outgoing message is sent when the time period has lapsed. If the user 320 wants to “abort” the release of the outgoing message from the buffering unit 354, then an abort command is provided from the UT 340 to the email server 350. The email server may be adapted to, in response of receiving the “abort” command, remove the outgoing message from the buffering unit 354.

According to one embodiment of the arrangement described in FIG. 3a-b, the time delay buffering unit 302, 354 may be adapted to only decrease the remaining time before the message is sent when input is registered by the I/O arrangement of the UT. Hence, the time for an outgoing message may depend on the user's actual use of the UT on order to ensure that the time delay represents user time. For example, if a user drafts an electronic message and invokes the “send” command and thereafter leaves the UT, the outgoing message may be held in the buffering unit 302, 354 until user interaction is again detected. When user interaction is detected, then the remaining time is again decreased.

With reference to FIG. 3c, a time diagram scenario for an outgoing electronic message in a buffer will now be described. The time diagram in FIG. 3c shows an example case where the user sends the outgoing message and thereafter leaves the UT which may be registered in that no further interaction is detected. The time diagram may be related to a scenario which may result from the flow described with reference to FIG. 2c above.

When the user invokes the “send” command, the outgoing electronic message is placed in the buffer and the countdown starts by decreasing the remaining time period, which is indicated by 371. Then, at a timing 372, the user stops to interact with the UT which results in that the countdown holds and no more time is decreased from the remaining time period.

When the UT again receives interaction from the user, indicated by timing 373, the countdown continues until the remaining time has lapsed indicated by timing 374. Thus, the countdown of the remaining time will be done in two separate time periods. A first time period 381 which is interrupted when the user leaves the UT and a second time period 382 which is commenced when user input is again detected and which ends when the remaining time period has lapsed.

With reference to FIG. 4, an email server 400 comprising a time delay buffer 410 serving multiple users will now be described. In this particular example, three UTs 401a-c are associated with the email server 400. However, the email server may be adopted to serve any number of UTs. The time delay buffer 410 may for each buffered outgoing message comprise a reference to the sending user, e.g. User A, User B or User C. The time delay buffer 410 may also comprise, for each message, a time indication indicating when the message may be sent, e.g. T_{send A} indicating the time period which has to lapse before message A is sent. If the user of, to the message associated UT, does not invoke any “abort” command, then the time delay buffer 410 automatically sends the message to the intended recipient. However, if an “abort” command is received, then the outgoing message is discarded and a new instance of the message has to be placed into the time delay buffer 410.

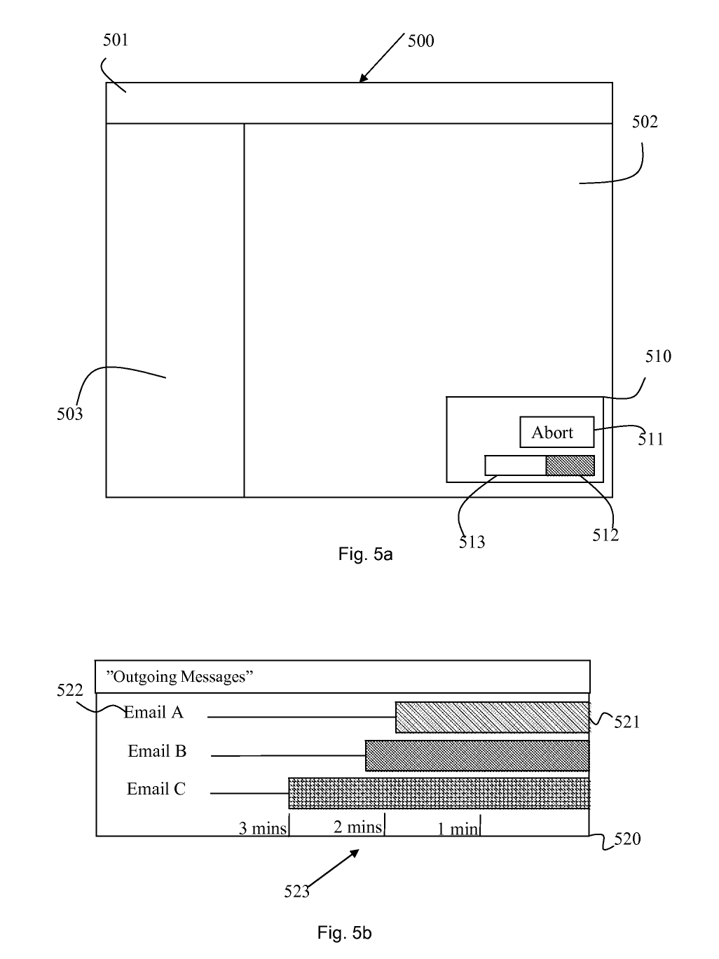

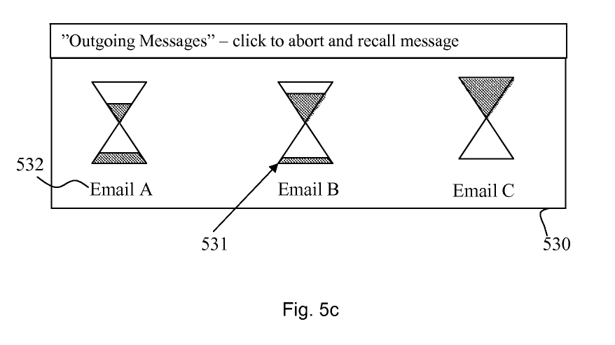

With reference to FIG. 5a, an example of a visual indicator of the remaining time before an outgoing electronic message is sent will be described. It shall be noted that this visualization is purely a non-limiting example. In this example, the GUI shows a main window 500 of a computer program for sending electronic messages comprising a menu 501. The main window 500 may also comprise other windows, such as an inbox folder window 503 and a text editing window 502 for editing and drafting electronic messages. The GUI also displays a group of graphical items 510 for indicating the remaining time before an outgoing electronic message is sent. In this example, the remaining time is illustrated by a progress bar having a remaining portion 512 and a lapsed portion 513. The group of graphical items 510 may also comprise an “abort” instruction or an abort button 511. According to one possible embodiment, the group of graphical items 510 is always displayed in a top layer of the GUI. Hence, no other group of graphical items can be placed on top and cover the indication of the remaining time.

With reference to FIG. 5b, another example of a visual indicator of the remaining time for each of the outgoing messages will now be described. It should be noted that this is only one of many possible embodiments. However, in the illustration of FIG. 5b, one progress bar 521 is associated with each outgoing electronic message 522. The user may hence easily see the remaining time 523 for each of the messages. The progress bars of FIG. 5b may be interactive and may decrease continuously in real time. According to one possible embodiment, the progress bar is accentuated, e.g. by blinking, when only short portion of the time period is left. According to one possible embodiment, the outgoing message may simply be aborted by clicking the progress bar or the message indication.

With reference to FIG. 5c, another example of a visual indicator of the remaining time for of the outgoing messages will now be described. In FIG. 5c, the remaining time is indicated and visualized by an hourglass 531. Each hourglass is associated with an email indication 532. According to one possible example, the user may invoke an “abort” command by clicking the time indicator, i.e., the hourglass, and thereby prevent the associated outgoing electronic message from being sent.

In another possible embodiment, the visual indicator of the remaining time may be an interactive animation or a video.

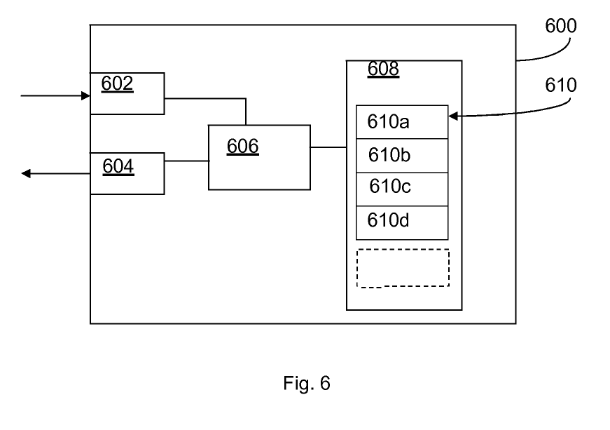

FIG. 6 schematically shows an embodiment of an arrangement 600 in a in a terminal and/or in a server for electronic messaging, which also can be an alternative way of disclosing an embodiment of the arrangements for handling outgoing electronic messages, which are illustrated in FIG. 3a-b. Comprised in the arrangement 600 is here a processing unit 606, e.g. a Digital Signal Processor (DSP). The processing unit 606 can be a single unit or a plurality of units to perform different actions of procedures described herein. The arrangement 600 may also comprise an input unit 602 for receiving signals and information from other entities, and an output unit 604 for providing signals and information to other entities. The input unit 602 and the output unit 604 may be arranged as an integrated entity. The input unit 602 and the output unit 604 may thus handle incoming commands from the user as well as sending electronic messages via WAN/Internet.

Furthermore, the arrangement 600 comprises at least one computer program product 608 in the form of a non-volatile memory, e.g. an Electrically Erasable Programmable Read-Only Memory (EEPROM), a flash memory and a disk drive. The computer program product 608 comprises a computer program 610, which comprises code means, which when run in the processing unit 606 in the arrangement 600 causes the arrangement and/or the terminal and/or the email server to perform the actions of the procedures described earlier in conjunction with FIG. 2-5c.

The computer program 610 may be configured as a computer program code structured in computer program modules. Hence in the example embodiments described, the code means in the computer program 610 of the arrangement 600 comprises a receiving module 610a for receiving commands from a user. The computer program further comprises a buffering module 610b for buffering and managing outgoing electronic messages. The computer program 610 further comprises a displaying module 610c for displaying the remaining time associated with an outgoing message to the user using a GUI. The computer program 610 further comprises a sending module 610d for sending the outgoing electronic message if no “abort” command has been received by the receiving module 610a and that the time period associated with the outgoing electronic message has lapsed. The outgoing message may be sent to a delivery server via the output unit 604. The user commands may be received via the input unit 602. The output unit 604 may also display the remaining time, according to GUI instructions using a screen connected to the arrangement 600.

The modules 610a-d could essentially perform the actions of the flow illustrated in FIG. 6, to emulate the arrangement in the terminal illustrated in FIG. 3a-c. In other words, when the different modules 610a-d are run on the processing unit 606, they correspond to the units 301-304 of FIG. 3a, or the corresponding units of FIG. 3b.

Although the code means in the embodiment disclosed above in conjunction with FIG. 6 are implemented as computer program modules which when run on the processing unit causes the arrangement and/or the UT 300 to perform the actions described above in the conjunction with figures mentioned above, at least one of the code means may in alternative embodiments be implemented at least partly as hardware circuits.

The processor may be a single central processing unit (CPU), but could also comprise two or more processing units. For example, the processor may include general purpose microprocessors; instruction set processors and/or related chips sets and/or special purpose microprocessors such as Application Specific Integrated Circuits (ASICs). The processor may also comprise board memory for caching purposes. The computer program may be carried by a computer program product connected to the processor. The computer program product comprises a computer readable medium on which the computer program is stored. For example, the computer program product may be a flash memory, a Random-access memory (RAM), Read-Only Memory (ROM) or an EEPROM, and the computer program modules described above could in alternative embodiments be distributed on different computer program products in the form of memories within the data receiving unit.

The solution which is presented in this description for handling outgoing electronic messages requires no knowledge of the content or the subject of an outgoing electronic message. Thus, the solution may also be compatible with any language with only minor or none adoptions. Hence, one solution may be used corporation-wide wherein the employees use different languages. The solution is easy for the user to understand and use. The solution for handling outgoing electronic messages is also easy for support personnel to maintain and setup compared to prior art systems for screening and analysis of electronic messages.

The solution presented above requires no dedicated computing resources for parsing and analyzing the content, context and meaning of the message. This solution is therefore scalable and may be implemented in a user terminal centric manner instead of centrally. The above presented solution may therefore be highly scalable, cheaper and more effective compared to the prior art systems decreasing unwanted outgoing electronic messages.

While the invention has been described with reference to specific exemplary embodiments, the description is generally only intended to illustrate the inventive concept and should not be taken as limiting the scope of the invention. While some Figs. above illustrate spatial relationships, it should be understood that functional relationships are generally superseding spatial relationship.

The invention is defined by the appended claims.

### ABBREVIATIONS

DSP—Digital Signal Processor

EEPROM—Electronically Erasable Programmable Read-Only Memory

GUI—Graphical User Interface HTTP—Hypertext Transfer Protocol IM—Instant Message

IMAP—Internet Message Access Protocol

LAN—Local Area Network

POP3—Post Office Protocol 3

RAM—Random Access Memory

ROM—Read Only Memory

SMTP—Simple Mail Transfer Protocol

UT—User Terminal

WAN—Wide Area Network

What is claimed is:

1. A method for handling an outgoing electronic message in a User Terminal (UT), said method comprising:
receiving a send command from a user of said UT, wherein said send command is associated with said outgoing electronic message;
buffering said outgoing electronic message in a time delay buffer for a predetermined time period;
displaying, to the user, using a Graphical User Interface (GUI) associated with the UT, an indicator of remaining time before said predetermined time period has elapsed; and
sending, without any further user interaction, said electronic message when said predetermined time period has lapsed.

2. A method according to claim 1, further comprising:
receiving an abort command from the user; and
removing said outgoing electronic message from said time delay buffer in response to said abort command.

3. A method according to claim 1, wherein said GUI comprises at least a top layer and a bottom layer of display, wherein said remaining time is displayed in said top layer.

4. A method according to claim 3, wherein said indicator of remaining time is continuously displayed as one of: an interactive progress bar, a numerical countdown indicator, a graphical countdown indicator, and a color indicator.

5. A method according to claim 1, wherein said predetermined time period is based on at least one of: an addressee of said outgoing electronic message, a number of addressees of said outgoing electronic message, a size of said outgoing electronic message, and a relationship between said outgoing electronic message and a previously received electronic message.

6. A method claim 1, wherein said predetermined time period represents a time period during which the UT registers user interaction.

7. A User Terminal (UT) for handling an outgoing electronic message, said UT comprising:
a receiving unit , adapted to receive a send command from a user of said UT, wherein said send command is associated with said outgoing electronic message;
a time delay buffering unit , adapted to buffer said outgoing electronic message for a predetermined time period;
a Graphical User Interface (GUI);
a display unit , adapted to display, to the user using said GUI, an indication of remaining time before said predetermined time period has elapsed; and
a sending unit, adapted to send said outgoing electronic message when said predetermined time periods has lapsed without receiving any further user interaction.

8. A UT according to claim 7, wherein said receiving unit is further adapted to receive an abort command from the user and instruct said buffering unit to remove said outgoing electronic message when the abort command is received.

9. A UT according to claim 7, wherein said GUI comprises at least a top layer and a bottom layer of display, wherein said remaining time is displayed in said top layer.

10. A UT according to claim 9, wherein said displaying unit is further adapted to display said remaining time as one of: an interactive progress bar, a numerical countdown indicator, a graphical countdown indicator, and a color indicator.

11. A UT according to claim 7, wherein said buffering unit is further adapted to set said predetermined time period based on at least one of: an addressee of said outgoing electronic message, a number of addressees of said outgoing electronic message, a size of said outgoing electronic message, and a relationship between said outgoing electronic message and a previously received electronic message.

12. A UT according to claim 7, wherein said buffering unit is further adapted to extend said predetermined time period based on whether or not user interaction is registered by said receiving unit.

13. A computer readable medium containing program instructions for handling an outgoing electronic message, wherein execution of the program instructions by a processor causes the processor to perform the steps of:
receiving a send command from a user of a user terminal (UT), wherein said send
command is associated with said outgoing electronic message;
buffering said outgoing electronic message in a time delay buffer for a predetermined time period;
displaying, to the user, using a Graphical User Interface (GUI) associated with the UT, an indicator of remaining time before said predetermined time period has elapsed; and
sending, without any further user interaction, said electronic message when said predetermined time period has lapsed.

14. A computer readable medium according to claim 13, wherein the program instructions further cause the processor to perform the steps of:
receiving an abort command from the user; and
removing said outgoing electronic message from said time delay buffer in response to said abort command.

15. A computer readable medium according to claim 13, wherein said GUI comprises at least a top layer and a bottom layer of display, wherein said remaining time is displayed in said top layer.

16. A computer readable medium according to claim 13, wherein said indicator of remaining time is continuously displayed as one of: an interactive progress bar, a numerical countdown indicator, a graphical countdown indicator, and a color indicator.

17. A computer readable medium according to claim 13, wherein said predetermined time period is based on at least one of: an addressee of said outgoing electronic message, a number of addressees of said outgoing electronic message, a size of said outgoing electronic message, and a relationship between said outgoing electronic message and a previously received electronic message.

18. A computer readable medium according to claim 13, wherein said predetermined time period represents a time period during which the UT registers user interaction.
